(19) United States
(12) Patent Application Publication
(10) Pub. No.: US 2026/0101120 A1
(43) Pub. Date: Apr. 9, 2026

(54) MOVABLE APPARATUS, CONTROL SYSTEM FOR MOVABLE APPARATUS, STORAGE MEDIUM, AND INFORMATION PROCESSING SYSTEM

(71) Applicant: CANON KABUSHIKI KAISHA, Tokyo (JP)

(72) Inventor: KENTA IGARASHI, Kanagawa (JP)

(21) Appl. No.: 19/342,024

(22) Filed: Sep. 26, 2025

(30) Foreign Application Priority Data
Oct. 8, 2024 (JP) 2024-176758

(51) Int. Cl. H04N 23/959; G05D 1/246; G05D 109/25; G05D 111/10; G05D 111/30; H04N 23/67

(52) U.S. Cl. CPC H04N 23/959; G05D 1/246; H04N 23/675; G05D 2109/254; G05D 2111/17; G05D 2111/30

(57) ABSTRACT

A movable apparatus includes a first acquisition unit that acquires position information for the movable apparatus as first information; a second acquisition unit that acquires information for a periphery of the movable apparatus as second information; a communications unit that communicates with an external apparatus; a memory storing instructions; and a processor executing the stored instructions causing the movable apparatus to generate a map of around the movable apparatus to serve as first map information based on the first information and the second information. Executing the stored instructions by the processor causes the movable apparatus to change at least one of information acquisition conditions for the second acquisition unit, and communication contents with the external apparatus based on a communication state with the external apparatus, and the first map information or second map information different from the first map information.

### BACKGROUND

### Field of the Technology

The present disclosure relates to a movable apparatus, a control method for a movable apparatus, a storage medium, and an information processing system.

### Description of the Related Art

Conventionally, a system is known in which an unmanned vehicle (a movable apparatus) is equipped with a variety of sensor devices and navigated, and map data (mapping information) is created. As the sensor devices with which this is equipped, a diversity of devices can be used, including image capturing elements such as a visible camera, a thermal camera, and the like, a measurement device such as LIDAR (Light Detection and Randing) and the like, GPS (Global Positioning System), and the like. The unmanned vehicle is controlled by remote operations from a host system that is configured by an information processing apparatus and the like. Information that has been acquired by the sensor devices that the unmanned vehicle has been equipped with is uploaded to the host system, and mapping information (map information) is created on the host system. Conversely, the mapping information is created in the unmanned vehicle by autonomous control of the unmanned vehicle, and the mapping information is uploaded to the host system.

It is assumed that the mapping that is used in the unmanned vehicle is executed in poor quality environments such as dangerous regions in which it is difficult for people to enter with the goal of relief aid at the time of a disaster, and the like. It is desirable that even in such poor quality conditions, the unmanned vehicle continuously acquires data.

In United States Patent Application, Publication No. 2023/0028196, a configuration is disclosed in which, in a case in which communications with a host system that performs the remote operations of a unmanned vehicle and monitoring of the acquired video images are disconnected, the unmanned vehicle performs autonomous movement control, and continues the collection of mapping information. A method is also disclosed in which the data that has been collected during this time is stored on a local region of the unmanned vehicle, and in a case in which the communications with the host system are recovered, the data that has been accumulated in this local region is uploaded to the host system.

However, in methods such as the above-described method, there is a possibility that the unmanned vehicle will navigate the same region. Due to this, there is a possibility that even if new data cannot be acquired, energy will be wastefully expended by the continuation of data acquisition. There are thereby cases in which it becomes difficult to restore the communications with the host system. If a power shortage is entered while communications with the host system have still not been restored, there is a possibility that the mapping information that has been collected will not be able to be recovered. Therefore, a decrease in the processing load in the unmanned vehicle, and thereby a decrease in the energy consumption such that it becomes possible to navigate for a longer period is desired.

### SUMMARY

The goal of the present disclosure is to provide a movable apparatus that is able to reduce energy consumption by reducing the processing load according to a state while acquiring information.

In order to achieve the above-described goal, a movable apparatus according to one aspect of the present disclosure includes a first acquisition unit configured to acquire position information for the movable apparatus to serve as first information; a second acquisition unit configured to acquire information for a periphery of the movable apparatus to serve as second information; a communications unit configured to communicate with an external apparatus; at least one memory storing instructions; and at least one processor executing the stored instructions causing the movable apparatus to generate a map of around the movable apparatus to serve as first map information based on the first information and the second information. Executing the stored instructions by the processor further causes the movable apparatus to change at least one of information acquisition conditions for the second acquisition unit and communication contents with the external apparatus based on a communication state with the external apparatus, and the first map information or second map information that is different than the first map information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an information processing system according to the First Embodiment.

FIG. 2 is a hardware configuration diagram of an information processing system of the First Embodiment.

FIG. 3 is a flowchart showing a processing method for the First Embodiment.

FIG. 4A, and FIG. 4B are diagrams explaining determination methods for whether a position of the unmanned vehicle is inside or outside of a range of map information.

FIG. 5A, and FIG. 5B are diagrams showing an unmanned vehicle, and an acquisition direction for information that is acquired by an image capturing unit with which this unmanned vehicle is equipped.

FIG. 6A, and FIG. 6B are diagrams of one example of a depth of field according to control of an optical system, and one example of a captured image that is assumed when this control has been performed.

### DESCRIPTION OF THE EMBODIMENTS

Below, details of the embodiments for executing the present disclosure will be explained. Note that the embodiments that are explained below are one example for realizing the present disclosure, and should be appropriately corrected and changed according to the configuration and each type of condition of the apparatus to which the present disclosure will be applied. The present disclosure is not limited to the following embodiment. In addition, in all of the figures, articles having the same function have been given the same numeric characters, and repeated explanations thereof will be omitted.

### First Embodiment

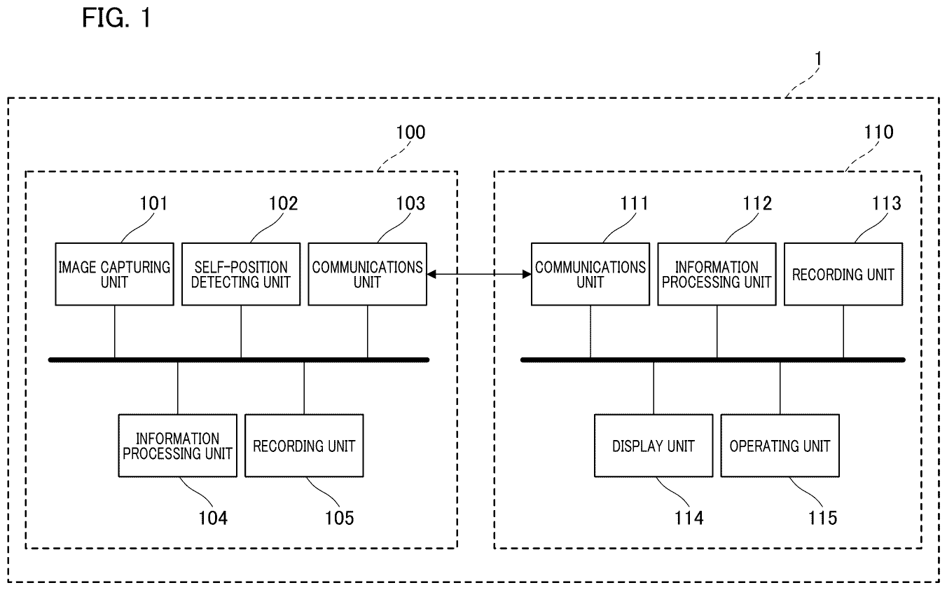

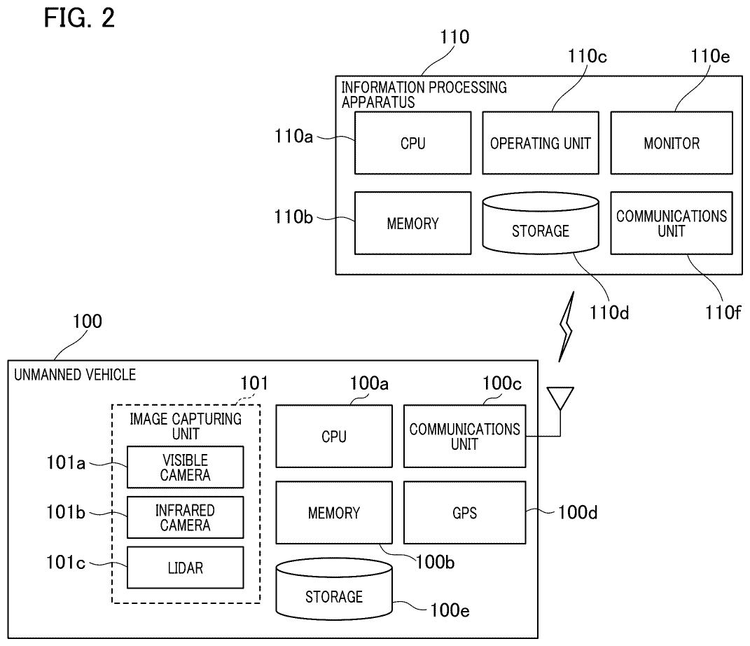

FIG. 1 is a functional block diagram of an information system 1 of the First Embodiment. FIG. 2 is a hardware configuration diagram of the information processing system 1 of the present embodiment. The information processing system 1 of the present embodiment is configured by an unmanned vehicle 100 and an information processing apparatus (external apparatus, host apparatus) 110. The unmanned vehicle 100 and the information processing apparatus 110 are communicably connected to each other. Below, the unmanned vehicle 100 and the information processing apparatus 110 of the information processing system 1 of the present embodiment will be explained with reference to FIG. 1, and FIG. 2.

The unmanned vehicle (movable apparatus) 100 is a moving apparatus that is configured by one of the modes of a flying apparatus such as a drone that navigates through the sky, a ship, or an automobile. For the explanation of the present embodiment, below, the unmanned vehicle 100 will be explained as a drone. The unmanned vehicle 100 has an image capturing unit 101, a self-position detecting unit 102, a communications unit 103, an information processing unit 104, and a recording unit 105.

The image capturing unit (a second acquisition unit, a camera unit) 101 functions as an image capturing unit that is configured by an optical system (image capturing optical system) that is configured by a plurality of lenses and an optical element such as a holding member and the like; and an image capturing element. The image capturing optical system forms a subject image by forming an image of light from a subject. In addition, the image capturing unit 101 has a configuration that is able to adjust (able to control) aperture and zoom power, and a focus position by one or more lens drive motors. These lens drive motors are controlled by an optical system control unit that is not shown.

The image capturing element has a semiconductor element such as a CMOS (Complementary Metal Oxide Semiconductor) sensor, a CCD (Charge Couple Device) sensor, and the like. The image capturing element captures images of subjects through the image capturing optical system (outputs images).

Note that the image capturing element that the image capturing unit 101 has may also be, for example, a solid image capturing element that captures images of visible light components (components with wavelengths of around 380 nm-780 nm) of the subject image, and outputs visible images. In addition, the image capturing element may also be an infrared image capturing element that captures images of nonvisible light components (components having wavelengths of around 800 nm to 1500 nm, and wavelengths of 3 um to 8 um, and around 8 um to 15 um) of the subject image, and outputs thermal images. In addition, the image capturing element may also be a measuring element such as a LIDAR sensor or the like that projects light onto the subject, and acquires distance information for the subject based on time information for until this reflected light is received.

The image capturing unit 101 may be provided with a plurality of different elements such as those that have been explained above. That is, the image capturing unit 101 may have a solid image capturing element, an infrared image capturing element, and a distance measuring element. Specifically, the image capturing unit 101 of the present embodiment has a visible camera 101a that has a solid image capturing element, an infrared camera 101b that has an infrared image capturing element, and a LIDAR (an optical apparatus having a sensing function) 101c that has a distance measuring element. Note that it is sufficient if the image capturing unit 101 has at least the solid image capturing element (visible light image capturing element) and the infrared image capturing element (infrared image capturing element). The image capturing unit 101 for example, acquires visible images of around the unmanned vehicle 100 from the visible camera 101a, infrared images of around the unmanned vehicle 100 from the infrared camera 101b, and distance information for a subject and the unmanned vehicle 100 from the LIDAR 101c to serve as the second information. The image capturing unit 101 outputs each image data and the distance information that have been acquired to the information processing unit 104.

Each piece of information (second information) that has been acquired by the image capturing unit 101 is output to the communications unit 103 and the information processing unit 104 together with detection information for the self-position detecting unit that will be described below (position information for the unmanned vehicle 100).

The self-position detecting unit 102 detects a position of the apparatus itself (the current position of the unmanned vehicle 100), and acquires this as position information (first information). Specifically, the self-position detecting unit 102 is for example, a GPS, and detects a position of the device itself by receiving signals from a plurality of satellites in the sky, and acquires 3-dimenstional measurement position information. The self-position detecting unit 102 outputs the 3-dimensional measurement position information that has been acquired to the information processing unit 104, and this is recorded on the recording unit 105. The signal that is received includes time information, and trajectory information for the satellites, and it is possible to calculate the distance information for a satellite by multiplying the difference between the time information and the time when this information was received by the transmission speed for the electronic waves. By performing this for a plurality of satellites, it is possible to infer the current position of the receiving device. Conversely, the self-position detecting unit 102 may also be a so-called electronic compass. By measuring geomagnetic horizontal components using an electric compass, the direction in which the apparatus itself is facing is detected. In addition, the self-position detecting unit 102 may also be an acceleration sensor. The acceleration sensor outputs a composite vector for gravity and the movement acceleration of the apparatus itself, and detects a posture of the apparatus itself by referencing the gravity information thereof. In this context, the self-position detecting unit 102 may also be configured by combining a plurality of devices, and the devices that are combined can be made arbitrary. For example, the self-position detecting unit 102 may be configured by both a GPS and an electronic compass, and it may also be made such that the self-position detecting unit 102 is configured by a GPS, an electronic compass, and an acceleration sensor.

The communications unit 103 performs communications with a communications unit 111 of the information processing apparatus 110 periodically or irregularly. For example, the communications unit 103 transmits each type of information that has been collected (position information that has been acquired by the self-position detecting unit 102, map information that has been created by the information processing unit 104 that will be described below, and the like) to the communications unit 111. In addition, the communications unit 103 performs the reception of map information that has been accumulated (map information that has been integrated).

The information processing unit 104 functions as a control unit configured to integrally control the entirety of the unmanned vehicle 100 such as the operations of the unmanned vehicle 100, the processing in the unmanned vehicle 100, and the like. The information processing unit 104 generates 3-dimensional map information to serve as map information for around the unmanned vehicle 100 based on the data that is output by the image capturing unit 101 (second information) and data that is output by the self-position detecting unit 102 (first information). That is, the information processing unit 104 generates 3-dimensional map information based on the image data that is output by the image capturing unit 101 and the 3-dimesnional position information for the position of the apparatus itself that is output by the self-position detecting unit 102. After this, the information processing unit 104 transfers the 3-dimensional map information that has been generated to the information processing apparatus 110 via the communications unit 103.

In addition, in the information processing apparatus 110, the 3-dimesnional map information that has been transferred is integrated with 3-dimensional map information that has been generated in the past, and is stored on a storage medium such as a storage unit 113 of the information processing apparatus 110 and the like. This operation (processing) is performed each time that 3-dimensional map information has been newly generated inside of the unmanned vehicle 100 and is transferred to the information processing apparatus 110. The 3-dimesnional map information thereby becomes the latest map information (that is constantly updated). At this time, the 3-dimensional map information is global map information (second map information). Note that the integration of the 3-dimensional map information that has been transferred to the information processing apparatus 110 may also be performed by, for example an information processing unit 112 of the information processing apparatus 110, which will be explained below, and this may also be performed by the information processing unit 104 of the unmanned vehicle 100. The 3-dimensional map information that has been generated in the past is not limited to the 3-dimesnional map information that has been generated by the same unmanned vehicle, and may also be information that has been generated by other unmanned vehicles.

In addition, the 3-dimensional map information that has been generated by the information processing unit 104 is also output to the recording unit 105 of the unmanned vehicle 100 and stored. At this time, the 3-dimensional map information is local map information (first map information). The local map information that is stored in the recording unit 105 of the unmanned vehicle 100 is integrated each time that additional 3-dimensional map information is generated by the information processing unit 104 of the unmanned vehicle 100. This operation (processing) is performed each time that new 3-dimensional map information is generated in the same manner as the above-described global map information and is output to the recording unit 105. The local map information thereby becomes map information that is constantly updated. In this manner, the global map information and the local map information are both updated every time that new 3-dimensional map information is generated by the information processing unit 104 based on the data that is output by the image capturing unit 101 (second information), and the data that is output by the self-position detecting unit 102 (first information).

In this context, the 3-dimensional measured position information that is acquired by the self-position detecting unit 102 is synchronized with the 3-dimensional map information that is generated by the information processing unit 104 and is also used in the detection of the position of the apparatus itself on the map information (on the map).

The information processing apparatus 110 has the communications unit 111, the information processing unit 112, the recording unit 113, a display unit 114, and an operating unit 115. The communications unit 111 performs communications with the communications unit 103 of the unmanned vehicle 100 periodically and irregularly. The communications unit 111, for example, transmits (transfers) the map information that has been accumulated (map information that has been integrated) to the communications unit 103. In addition, the communications unit 111 performs the reception of each piece of information that has been collected by the unmanned vehicle 100 (the position information that has been acquired by the self-position detecting unit 102, map information that has been created by the information processing unit 104 that will be described below, and the like). The information processing unit 112 integrally controls the entirety of the information processing apparatus 110. In addition, the information processing unit 112 performs the generation of map information from each information that has been transmitted (transferred) from the unmanned vehicle 100, and the integration of the map information that has been accumulated with the new map information that has been transferred, and stores the integrated data in the recording unit 113.

The display unit 114 is configured by a monitor and a display, and displays the information (for example, image data) that has been transmitted (transferred) from the unmanned vehicle 100 on a screen. The operating unit 115 is configured by an operating unit such as a keyboard and mouse, a controller, a lever, and the like. The movement control of the unmanned vehicle 100 and the control of the information acquisition conditions for the information processing unit 104 can be performed by the user (operator) operating the operating unit 115 (manned operation).

In this context, the movement control of the unmanned vehicle 100 that is performed via the operating unit 115 is a drive control such as changing the position of the unmanned vehicle 100, and, for example, if this is a flying drone that has been provided with a plurality of propellors, is control that changes the rotational speed of each propellor. The control of the information acquisition conditions is control of changing, for example, the exposure time and gain of the visible camera, and control according to the optical system such as the focus, the zoom magnification, and the like of the visible camera. The movement control of the unmanned vehicle 100 and the control of the information acquisition conditions does not necessarily need to be performed by the information processing apparatus 110, and may also be independent control by just the unmanned vehicle 100 based on the processing results for the information processing unit 104. In this manner, the information processing apparatus 110 also functions as a host system in which movement control for the unmanned vehicle 100, control of the information acquisition conditions, and the like are performed by user operations.

Referring to FIG. 2, the unmanned vehicle 100 is configured so as to have, as its hardware configuration, a CPU 100a, a memory 100b, a communications unit 100c, a GPS 100d, and a storage 100e.

The CPU (processor) 100a is a central processing apparatus configured to execute each type of processing by reading out a control program that has been stored on the memory 100b, and integrally controls the unmanned vehicle 100. The memory 100b is configured by a ROM and a RAM, and configures the above-described recording unit 105. The ROM is a non-volatile memory, and stores programs for each embodiment, other programs necessary for the control (control programs), and each type of data. The RAM is a volatile memory, and is used as a primary memory for the CPU 100a, and a temporary storage region such as a working area, and the like.

The communications unit 100c configures the above-described communications unit 103, and therefore, a detailed explanation thereof will be omitted. The GPS 100d configures the above-described self-position detecting unit 102, and therefore, a detailed description thereof will be omitted. The storage 100e stores each type of data, each type of program, and the like. The storage 100e is a storage device such as an HDD, a flash memory, an SD card, and the like. The storage 100e is also used as a short term storage region for each type of data and the like in addition to being used as a permanent storage region for an OS (operating system), each type of program, each type of data, and the like. Note that the storage 100e may also configure the above-described recording unit 105.

The information processing unit 110 is configured so as to have, as its hardware configuration, a CPU 110a, a memory 110b, an operating unit 110c, a storage 110d, a monitor 110e, and a communications unit 100f.

The CPU (processor) 110a is a central processing apparatus that executes each kind of processing by reading out a control program that has been stored on the memory 110b, and integrally controls the information processing apparatus 110. The memory 110b is configured by a ROM and a RAM, and configures the above-described recording unit 113. The ROM is a non-volatile memory, and stores programs for each embodiment, other programs necessary for control (control programs), and each type of data. The RAM is a volatile memory, and is used as a main memory for the CPU 110a, and a temporary storage region such as a work area and the like.

The operating unit 110c configures the above-described operating unit 115 and therefore, a detailed explanation thereof will be omitted. The storage 110d stores each type of data, each type of program, and the like. The storage 110d is a storage device such as an HDD, a flash memory, an SD card, and the like. The storage 110d is also used as a short term storage region for each type of data and the like in addition to being used as a permanent storage region for an OS, each type of program, each type of data, and the like. Note that the storage 110d may also configure the above-described storage unit 113. The monitor 110e configures the above-described display unit 114, and therefore, a detailed description thereof will be omitted. The communications unit 110f configures the above-described communications unit 111, and therefore, a detailed description thereof will be omitted.

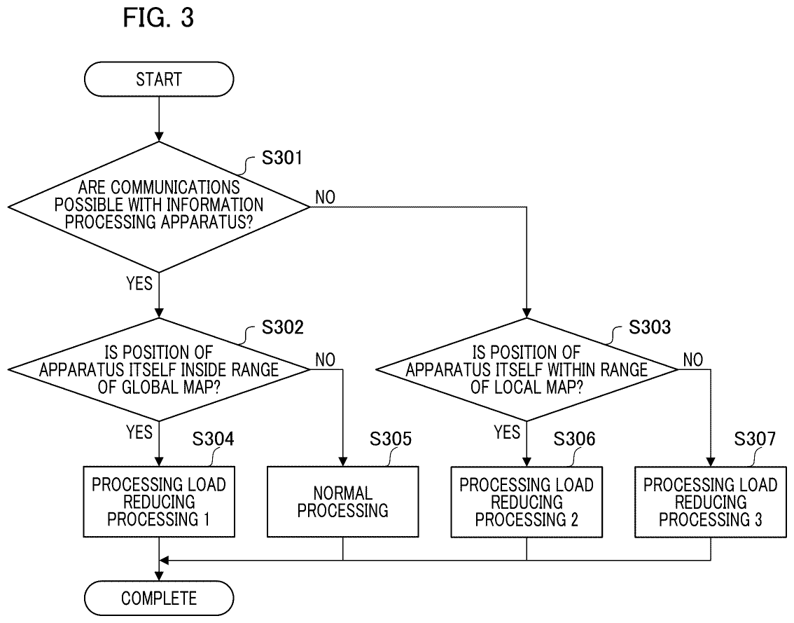

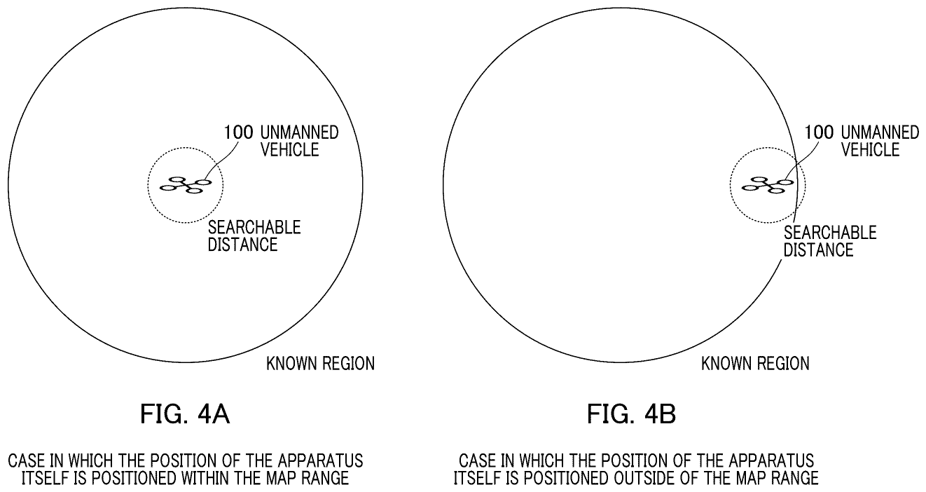

Below, a processing method in the information processing system 1 of the present embodiment will be explained with reference to FIG. 3 to FIG. 6. FIG. 3 is a flowchart showing one example of processing that is performed by the unmanned vehicle 100. FIG. 4A and FIG. 4B are diagrams explaining methods for determining whether or not the unmanned vehicle 100 is within a range of map information. Note that each operation (processing) that is shown in the flowchart in FIG. 3 is realized (controlled) by the CPU 100a of the unmanned vehicle 100 executing a program that has been stored on the memory 100b. In addition, the notation of a process (step) will be omitted by adding an S to the front of the notation of each process (step).

During S301, the information processing unit 104 determines whether or not communications are possible between the unmanned vehicle 100 and the information processing apparatus 110 (the possibility of communications). That is, the information processing unit 104 determines whether or not communications are possible between the communications unit 103 of the unmanned vehicle 100 and the information processing apparatus 110. In the case that it has been determined that communications are possible between the unmanned vehicle 100 and the information processing apparatus 110, the processing proceeds to S302. In contrast, in a case in which it has been determined that communications between the unmanned vehicle 100 and the information processing apparatus 110 are not possible, the processing proceeds to S303. In this context, when it is determined whether or not communications between the unmanned vehicle 100 and the information processing apparatus 110 are possible, for example, it is determined that “communications are not possible” if a movement control communication or a change control communication for the information acquisition conditions has not been performed from the information processing apparatus 110 to the unmanned vehicle 100 within a fixed period of time. Conversely, an upload of the map information and the like from the unmanned vehicle 100 to the information processing apparatus 110 may be performed using two-way communications, and the determination of whether or not communications are possible may also be performed according to the presence or absence of a return communication from the information processing apparatus 110 indicating that the communication has been normally completed.

During S302, the information processing unit 104 determines whether or not the current position of the device itself is within a range of the map based on the map information. That is, the information processing unit 104 determines whether or not the current position of the apparatus itself is located within the range of the global map. In a case in which it has been determined that the position of the device itself is located within the range of the global map, the processing proceeds to S304. In contrast, in a case in which it has been determined that the position of the device itself is not located within the range of the global map (that the position of the device itself is outside of the range of the global map), the processing proceeds to S305. In this context, during S302, the unmanned vehicle 100 is in a state in which it is possible to communicate with the information processing apparatus 110, and therefore, the unmanned vehicle 100 receives a portion of the global map information that has accumulated in the information processing apparatus 110 from the information processing apparatus 110 to serve as known region information. The known region information that has been received may be limited to within a set distance range based on the position information of the unmanned vehicle 100. In this context, the determination of whether or not the unmanned vehicle 100 is within a range of known region information is determined in the manner described below. In a case in which a second distance range with the position of the device itself at the center is made a searchable distance, and a portion or the entirety of this searchable range deviates from the range of the known region information, the information processing unit 104 determines that the position of the device itself is located outside of the range of the global map. The state at such a time is shown in FIG. 4B. In contrast, in a case in which all of (the entirety of) the searchable region is contained within the range of the known region information that has already been acquired, the information processing unit 104 determines that the position of the device itself is within the range of the global map. The state at such a time is shown in FIG. 4A.

During S303, the information processing unit 104 determines whether or not the current position of the device itself is within the range of the map based on the map information. That is, it is determined whether or not the position of the device itself is located within the range of the local map. In a case in which it has been determined that the position of the device itself is located within the range of the local map, the processing proceeds to S306. In contrast, in a case in which it has been determined that the position of the device itself is not located within the range of the local map (the position of the device itself is outside of the range of the local map), the processing proceeds to S307. In this context, during S303, communication with the information processing apparatus 110 is not possible, and therefore, the local map information is treated as known region information. After this, using the same as S302, the information processing unit 104 determines whether the position of the device itself is within the range of the local map or outside of the range of the local map.

During S304, the information processing unit 104 executes processing load reducing processing 1 (a first control). The processing load reducing processing 1 is change processing for the information acquisition conditions for the unmanned vehicle 100 (image capturing conditions), and change processing for the contents of the communications. Below, the processing load reducing processing 1 will be explained in detail.

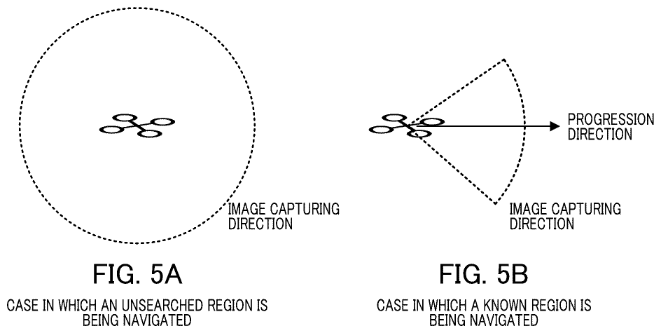

FIG. 5A and FIG. 5B are diagrams showing the acquisition direction for information that is acquired by the unmanned vehicle 100 and the image capturing unit 101 that has been installed in the unmanned vehicle 100. In the present embodiment, the visible video image that has been acquired by the unmanned vehicle 100 is transferred to the display unit 114 of the information processing apparatus 110 via the communications unit 111, and the user performs operations to control the unmanned vehicle 100 while confirming the visible video image on the screen of the display unit 114. In a case such as navigating in an un-searched region, image capturing is performed in all directions to serve as the periphery of the unmanned vehicle 100 as is shown in FIG. 5A in order to acquire information for the peripheral environment. However, in a case in which a known region is being navigated, the map information for around this region has already been acquired, and it is not necessary to acquire multidirectional images and video images, and high definition images and video image of this region. Therefore, during S304, the information processing unit 104 limits the amount of information for the second information that is acquired by the image capturing unit 101 (for example, limits the direction of the acquisition of the second information). In this case, for example, the information processing unit 104 controls the image capturing unit 101 and the like in a manner such that the image capturing direction is limited to the only the progression direction of the unmanned vehicle 100 as in FIG. 5B. Specifically, in a case in which the unmanned vehicle 100 is provided with a plurality of cameras, the information processing unit 104 stops the cameras other than the camera that is capturing images of the procession direction. Furthermore, in a case in which there is a plurality of cameras capturing images from the same angle of view, only one of these cameras is used.

In addition, control may also be performed to stop the image capturing by the image capturing unit 101 and transfer only the position information for the apparatus itself for the unmanned vehicle 100 to the information processing unit 110. In other words, control may also be performed to change the information that is transferred to the information processing apparatus 110. In this case, the information processing apparatus 110 selects the 3-dimensional map information that should be displayed based on the position information for the apparatus itself for the unmanned vehicle 100, and displays it on a screen of the display unit 114. As the 3-dimensional map information that should be displayed, the information processing apparatus 110 calculates the progression direction from displacement in the position information, and selects the progression direction based on this position information. Conversely, the transfer rate (compression rate) for the image data that has been captured may also be changed and output. Specifically, high definition image capturing is not necessary in a known region, and therefore, highly compressed image data (information in which the image quality has been reduced) is transferred to the information processing apparatus 110. In addition, instead of the compression ratio, information that has been acquired by dropping the frame rate of one of the camera video images may also be transmitted to the information processing apparatus 110, and changing the frame rate and changing the compression ratio may also be combined.

Note that the processing load reducing processing 1 may stop operations to acquire information for each apparatus in the image capturing unit 101 (the visible camera 101a, the infrared camera 101b, the LIDAR 101c) that has stopped outputting information. The information processing unit 104 executes processing such as the above-described change processing for the information acquisition conditions, and change processing for the communications content to serve as the processing load reducing processing 1. In this manner, the first control is performed in a case in which there is a state in which communications are possible between the unmanned vehicle 100 and the information processing apparatus 110, and the current position of the unmanned vehicle 100 is within the global map (a case in which the position of the unmanned vehicle 100 is located in a range of the map based on the second map information).

During S305, the information processing unit 104 executes regular processing without performing processing to reduce the processing load for the unmanned vehicle 100. In other words, during S305, the information processing unit 104 does not perform the change processing for the information acquisition conditions for the unmanned vehicle 100, and the change processing for the communication contents. Normal processing is, for example, processing for acquiring 3-dimensional measured position information and generating map information for unsearched regions. This processing generates map information in unsearched regions, and therefore, uses the visible camera 101a, the infrared camera 101b, and the LIDAR 101c, and collects the necessary information for the generation of map information. This information collection is performed by capturing images in multiple directions with the position of a specific unmanned vehicle at the center. In addition, the unmanned vehicle 100 generates map information based on the collected information and transfers the map information to the information processing apparatus 110. Furthermore, manned operation of the unmanned vehicle 100 by a user is assumed, and therefore, the information processing unit 104 transfers the visible camera video image to the information processing apparatus 110 in order to perform operations to control the unmanned vehicle 100. In this manner, the normal processing is performed in a case in which there is a state in which communications are possible between the unmanned vehicle 100 and the information processing apparatus 110, and the current position of the unmanned vehicle 100 is not in the range of the global map (a case in which the position of the unmanned vehicle 100 is not located in the range of the map based on the second map information).

During S306, the information processing unit 104 executes processing load reducing processing 2. The processing load reducing processing 2 is processing that performs changes to the image capturing conditions and changes to the recording contents. Below, the details of the processing load reducing processing 2 will be explained.

In a case in which the processing has proceeded to S306, this is a state in which communications are not being performed between the unmanned vehicle 100 and the information processing apparatus 110. Therefore, until communications are restored between the unmanned vehicle 100 and the information processing apparatus 110, it is assumed that the unmanned vehicle 100 repeats standby, and autonomous movement control. In this context, during S306, the unmanned vehicle 100 acquires information for its own periphery by using the visible camera and the like that are used in the map information acquisition in order to maintain the safety of itself during this period (the period until communications between the unmanned vehicle 100 and the information processing apparatus 110 are restored).

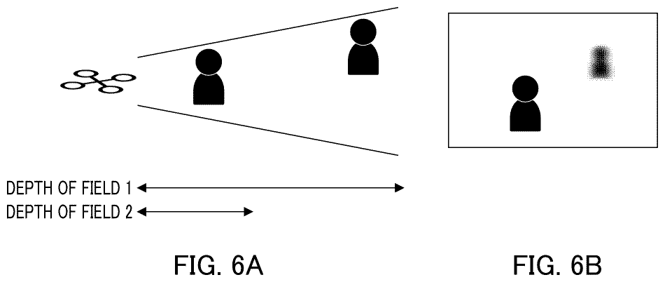

FIG. 6A and FIG. 6B are diagrams showing one example of a depth of field according to control of the optical system, and one example of a captured image that is imagined in a case in which this control has been performed. FIG. 6A is a diagram showing one example of a depth of field according to control of the optical system, and FIG. 6B is a diagram showing one example of a captured image that is imagined in a case in which control of the optical system has been performed.

The depth of field for the visible camera 101a during the map information acquisition may be captured widely from close to far away, as is shown in the depth of field 1 in FIG. 6A. However, during autonomous control, emphasis is placed on nearby moving object detection. This is because there is a possibility that precise image capturing of a subject that is far away will cause idle image processing. An example of idle image processing is shown in FIG. 6B. In this context, as the processing load reducing processing 2, it is made easy to handle far away subjects as the background, and idle image processing is avoided by purposefully removing the depth of field from subjects that are far away and that there is no need to acquire, as in the depth of field 2 shown in FIG. 6A. In other words, the information processing unit 104 performs control such that the depth of field of the optical system of the image capturing unit 101 is narrowed (condensed) to the direction of the unmanned vehicle 100 by just a predetermined amount.

Note that as a replacement or combined means, 2×2 pixel addition may also be further performed for the image capturing resolution, thereby reducing the image capturing resolution. In other words, the information processing unit 104 may also control the settings for the resolution of the image capturing element such that the resolution becomes smaller than a control value. In addition, although in the present embodiment, a drive unit such as the above-described lens drive motor and the like is provided, the above-described control method can also be applied to cases in which a drive unit such as a lens drive motor, and the like has not been provided. In this manner, the second control is performed in a case in which there is a state in which communications are not possible between the unmanned vehicle 100 and the information processing apparatus 110, and the current position of the unmanned vehicle 100 is within the range of the local map (in a case in which the position of the unmanned vehicle 100 is within a range of the map based on the first map information).

During S307, the information processing unit 104 executes processing load reducing processing 3. The processing load reducing processing 3 is processing that performs changes to the recording contents. Below, the processing load reducing processing 3 will be explained in detail.

In a case in which the unmanned vehicle 100 collects information for an unsearched region during a period in which communications cannot be performed with the information processing apparatus 110, each piece of information that has been collected by the unmanned vehicle 100 is recorded on the recording unit 105 of the unmanned vehicle 100. Normally, information that has been acquired by the image capturing unit 101, map information that has been generated, and the position information for the apparatus itself are assumed as the information that is recorded in the recording unit 105. In this context, during the processing load reducing processing 3 during S307, the information that is recorded in the recording unit 105 is limited to a portion of the information according to the goal of the user (operator). For example, there are cases in which only the visible images that are acquired by the visible camera 101a are recorded in the recording unit 105, and cases in which only the infrared images that are captured by the infrared camera 101b are recorded in the recording unit 105. In this manner, the third control is performed in a case in which there is a state in which communications between the unmanned vehicle 100 and the information processing apparatus 110 are not possible, and the current position of the unmanned vehicle 100 is not within the range of the local map (a case in which the position of the unmanned vehicle 100 is not located in a range of the map based on the first map information).

According to the above-described processing, the information processing unit 104 of the unmanned vehicle 100 is able to change at least one of the information acquisition conditions in the image capturing unit 101, and the communication contents with the information processing apparatus 110 based on the communication state of the information processing apparatus 110, and the first map information, and the communication state of the information processing apparatus 110 and the second map information. More specifically, the information processing unit 104 determines each of whether or not communications are possible with the information processing apparatus 110, the presence or absence of first map information, and the presence or absence of second map information, and according to these determination results, changes at least one of the information acquisition conditions for the image capturing unit 101, and the communication contents with the information processing apparatus 110.

Note that although S304, S306, and S307 have each explained different processing for reducing the processing load of the unmanned vehicle 100, the present disclosure is not limited thereto. For example, the method that was explained during S306 may also be executed during S307, and the processing load reducing processing 1-3 may also be combined and executed.

As was described above, in the present embodiment, each of whether or not communications are possible with the information processing apparatus 110, the presence or absence of first map information, and the presence or absence or of second map information are detected, a portion of the regular processing is simplified or made unactive according to these determination results, and the processing load in the unmanned vehicle 100 is thereby reduced. According to this, in a case in which the processing has transferred to processing other than the normal processing, it is possible to provide an information processing system including an unmanned vehicle 100 that makes it possible to reduce the energy consumption so as to make it smaller than the energy consumption for the regular processing, and that can be efficiently used.

Although embodiments of the present disclosure have been described above using examples and figures, the present disclosure is not limited to these embodiments, and a variety of alterations and changes are possible within the scope of the gist of the present disclosure.

According to the present disclosure, it is possible to provide a movable apparatus that is able to acquire information while reducing the amount of energy consumed by reducing the processing load according to the state of the movable apparatus.

### Other Embodiments

A computer program that realizes the functions of each of the examples in which a portion or the entirety of the control in the above-described embodiments have been described may also be provided to the unmanned vehicle 100, the information processing apparatus 110, a system, and the like via a network or each type of storage medium. In addition, it may also be made such that a computer (additionally, a CPU, an MPU, and the like) in this system and apparatus executes the program by reading it out. In this case, this program, and the storage medium on which this program has been stored configure the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176758 filed Oct. 8, 2024, which is hereby incorporated by reference herein in its entirety.

What is claimed is:

1. A movable apparatus comprising:
a first acquisition unit configured to acquire position information for the movable apparatus to serve as first information;
a second acquisition unit configured to acquire information for a periphery of the movable apparatus to serve as second information;
a communications unit configured to communicate with an external apparatus;
at least one memory storing instructions; and
at least one processor executing the stored instructions causing the movable apparatus to:
generate a map of around the movable apparatus to serve as first map information based on the first information and the second information; wherein
executing the stored instructions by the processor further causes the movable apparatus to change at least one of information acquisition conditions for the second acquisition unit, and communication contents with the external apparatus based on a communication state with the external apparatus, and the first map information or second map information that is different from the first map information.

2. The movable apparatus according to claim 1, wherein executing the stored instructions by the processor further causes the movable apparatus to determine each of whether or not the communications with the external apparatus are possible and presence or absence of the first map information or the second map information, and to change at least one of the information acquisition conditions for the second acquisition unit, and the communication contents with the external apparatus according to determination results.

3. The movable apparatus according to claim 1, wherein executing the stored instructions by the processor further causes the movable apparatus to perform a first control in a case in which there is a state in which communications with the external apparatus are possible, and a current position of the movable apparatus is located within a range of a map based on the second map information.

4. The movable apparatus according to claim 1, wherein executing the stored instructions by the processor further causes the movable apparatus to not perform changes to the information acquisition conditions for the second acquisition unit, and the communication contents with the external unit in a case in which there is a state in which communications with the external apparatus are possible, and a current position of the movable apparatus is not located within a range of a map based on the second map information.

5. The movable apparatus according to claim 1, wherein executing the stored instructions by the processor further causes the movable apparatus to perform a second control in a case in which there is a state in which communications with the external apparatus are not possible, and the current position of the movable apparatus is located within a range of a map based on the first map information.

6. The movable apparatus according to claim 1, wherein executing the stored instructions by the processor further causes the movable apparatus to perform a third control in a case in which there is a state in which communications with the external apparatus are not possible, and a current position of the movable apparatus is not within a range of a map based on the first map information.

7. The movable apparatus according to claim 1, wherein the first map information is information in which every time new first map information is generated, this map information is integrated with first map information that was generated in the past.

8. The movable apparatus according to claim 1, wherein the second map information is information in which current first map information that has been generated in the movable apparatus is integrated with first map information that was generated in the past.

9. The movable apparatus according to claim 1, wherein the second map information is information that is transmitted from the external apparatus and received by the communications unit.

10. The movable apparatus according to claim 3, wherein the first control is a control in which an information amount for the second information that is acquired by the second acquisition unit is limited, a control in which information that is transmitted from the communications unit to the external apparatus is changed, or both.

11. The movable apparatus according to claim 3, wherein during the first control, executing the stored instructions by the processor further causes the movable apparatus to control the second acquisition unit so as acquire information only in a progression direction of the movable apparatus.

12. The movable apparatus according to claim 3, wherein during the first control, executing the stored instructions by the processor further causes the movable apparatus to transmit one of the first information or the second information to the external apparatus,
wherein the second information is a video image, or an image that have been image captured by a camera; and
wherein executing the stored instructions by the processor further causes the movable apparatus to, in a case in which during the first control, the second information is transmitted to the external apparatus, transmit information in which a frame rate has been changed, and transmit information in which image quality has been lowered.

13. The movable apparatus according to claim 5, wherein the second information is a video image, or an image that have been image captured by a camera, and
wherein the second control is a control that compresses a depth of field for an optical system had by the camera to a direction of the movable apparatus by a predetermined amount.

14. The movable apparatus according to claim 5, wherein the second information is a video image, or an image that have been image captured by a camera; and
wherein the second control is control that sets a focus of an image capturing element had by the camera so as to be smaller than a control value.

15. The movable apparatus according to claim 6, further comprising:
a recording unit configured to record the first information, the second information, and the first map information; wherein
the third control is a control that changes contents of the second information that is recorded in the recording unit.

16. The movable apparatus according to claim 1, wherein the second acquisition unit has at least one of a visible camera, an infrared camera, and a LIDAR (Light Detection and Ranging).

17. A control method for a movable apparatus, the control method comprising:
acquiring position information for the movable apparatus to serve as first information;
acquiring information for a periphery of the movable apparatus to serve as second information;
communicating with an external apparatus; and
generating a map of around the movable apparatus to serve as first map information based on the first information and the second information; wherein
during generation of the first map information, at least one of information acquisition conditions during acquisition of the second information, and communication contents with the external apparatus are changed based on a communication state with the external apparatus, and the first map information or, second map information that is different than the first map information.

18. A non-transitory storage medium storing a program of a movable apparatus causing a computer to perform each step of a method for controlling the movable apparatus, the method comprising:
acquiring position information for the movable apparatus to serve as first information;
acquiring information for a periphery of the movable apparatus to serve as second information;
communicating with an external apparatus; and
generating a map of around the movable apparatus to serve as first map information based on the first information and the second information; wherein
during generation of the first map information, at least one of information acquisition conditions for during acquisition of the second information, and communication contents with the external apparatus are changed based on a communication state with the external apparatus, and the first map information or second map information that is different than the first map information.

19. An information processing system configured by a movable apparatus and an information processing apparatus that is communicably connected to the movable apparatus,
the movable apparatus comprising:
a first acquisition unit configured to acquire position information for the movable apparatus to serve as first information;
a second acquisition unit configured to acquire information for a periphery of the movable apparatus to serve as second information;
a first communications unit configured to communicate with an external apparatus;
at least one memory storing instructions; and
at least one processor executing the stored instructions causing the movable apparatus to:
generate a map of around the movable apparatus to serve as first map information based on the first information and the second information; wherein
executing the stored instructions by the processor further causes the movable apparatus to change at least one of information acquisition conditions for the second acquisition unit, and communication contents with the external apparatus based on a communication state with the external apparatus, and the first map information or second map information that is different from the first map information; and
the information processing apparatus comprising:
a second communications unit configured to communicate with the movable apparatus; and
an operating unit configured to control movement of the movable apparatus.
